(19) United States
(12) Patent Application Publication
(10) Pub. No.: US 2009/0159309 A1
(43) Pub. Date: Jun. 25, 2009

(54) Flat cable and plasma display device

(76) Inventors: Hidehiro Kanada, Kunitomi (JP); Nobuyoshi Kondo, Kunitomi (JP)

Correspondence Address: MCDERMOTT WILL & EMERY LLP, 600 13TH STREET, N.W., WASHINGTON, DC, 20005-3096, US

(21) Appl. No.: 11/919,122

(22) PCT Filed: Aug. 22, 2005
(86) PCT No.: PCT/JP2005/015215

§ 371 Date: Nov. 12, 2008

(51) Int. Cl. H01B 7/08

(52) U.S. Cl. 174/117 F

(57) ABSTRACT

A highly reliable flat cable is disclosed in which a short-circuit between adjacent electrodes due to whisker formation is prevented and the occurrence of contact failure between electrodes due to a foreign particle is prevented. A plasma display using this flat cable is also disclosed. The flat cable comprises a plurality of conductors and a pair of films having adhesive applied on the films so as to sandwich each of the conductors with a predetermined spacing. The conductors on the side of the flat cable or the conductors on the side of a connector electrically connected to the conductors on the side of the flat cable are formed of a lead-free material. Further, at a connecting portion of the flat cable, one of the films (2, 3) on which the adhesives (2a, 3a) are applied is removed to expose the conductors (1) to form electrodes (1a). A cover (11) is provided on the electrodes (1a) from which the film (2) has been removed. The cover is an insulating member having a partition wall (11a) between the adjacent electrodes (1a) and has openings formed in a hole shape or a comb shape at the portions of the electrodes (1a) of the flat cable.

### TECHNICAL FIELD

The present invention relates to a technology for a flat cable. More particularly, the present invention relates to a technology effectively applied to a flexible flat cable (FFC) for use in a plasma display device and others.

### BACKGROUND ART

For example, the FFC is obtained by laminating polyester films, to which flameproof polyester adhesive is applied, to a plurality of conductors from above and below. Since the FFC is thin and flexible, it is mainly used for the wirings between substrates in an electronic device (for example, Patent Document 1). When the FFC is to be used, a connecting portion having exposed electrodes is attached to a connector on a substrate side to establish the electrical connection. In this attachment, the FFC is inserted or pressed into the connector on the substrate side.

Patent Document 1: Japanese Patent Application Laid-Open Publication No. 2002-25641

### DISCLOSURE OF THE INVENTION

Problem to be Solved by the Invention

However, in the FFC as described above, the following problems occur, and the solution of the problems is desired.

(1) Short-circuit between adjacent electrodes due to whisker formation

The whisker is formed at a contact portion between an electrode exposed to a connecting portion of an FFC and an electrode on a connector side, and it causes the short-circuit between the electrodes in some cases. The whisker is a fibrous single-crystal metal formed and grown on a metal surface, and most of them have the diameter of several μm and the length of up to several hundred μm. This phenomenon has long been known, and the formation thereof is frequently observed particularly in tin. Although the detailed mechanism of its formation and growth has not been clarified yet, it is generally interpreted that the whisker is caused due to the internal stress of metal. Actually, the whisker formation is observed particularly at the grain boundary of the metal surface and at a portion where metals are in contact.

On the other hand, in the recent electronic devices, as the technology of containing no lead, that is, as a part of the so-called lead-free technology, the tin solder has been used more frequently, and the space between components has become more and more narrow with the progress in the high-density packaging. Therefore, the formation of the whisker becomes more obvious and the short-circuit between electrodes becomes a serious problem. Especially, since the generation of the compressive stress is indispensable in the connector, the suppression of the whisker formation and the measures after the whisker formation are essential tasks to be accomplished. FIG. 9 shows the state where the whisker is formed, in which a whisker 103 is formed at the contact portion between an electrode 101a of an FFC 101 and an electrode 102a of a connector 102.

(2) Contact failure due to foreign particle between electrodes

The adhesive as well as the electrode are exposed at the connecting portion of the FFC. Since the adhesive is made of a soft material in order to secure the flexibility of the FFC, when the FFC is to be connected to the connector, the contact failure occurs in some cases due to a foreign particle from the adhesive. More specifically, due to the oblique insertion and the misalignment at the time of connecting the FFC, the soft adhesive is shaved by the tip of the connector and others and the shavings of the adhesive are produced, and the shavings are attached as the foreign particles to the contact portion. FIG. 10A to FIG. 10D show the state where the adhesive is shaved and trapped due to the oblique insertion, and a foreign particle 104 of the shaved adhesive is trapped between the electrode 101a of the FFC 101 and the electrode 102a of the connector 102.

Particularly, since not only the foreign particle is small but also it is thin and transparent, it is difficult to find it. Further, even though a product is normal at the time of the shipment, the contact failure is found therein a little later after the shipment in some cases. Such a failure cannot be detected even if the operation test is performed before the shipment. As described above, the foreign particle produced at the time of connecting the FFC causes the product failure not only during the manufacturing process but also after the shipment to the market, and it takes a lot of time and expense to take care of the failure, combined with the difficulty of finding the failure. Accordingly, the measures capable of suppressing the production of the foreign particle itself have been demanded.

Therefore, an object of the present invention is to provide a reliable flat cable capable of preventing the short-circuit between adjacent electrodes due to whisker formation and preventing the occurrence of the contact failure due to the foreign particle between the electrodes and to provide a plasma display device using the flat cable.

The above and other objects and novel characteristics of the present invention will be apparent from the description of this specification and the accompanying drawings.

Means for Solving the Problems

The typical ones of the inventions disclosed in this application will be briefly described as follows.

That is, the present invention is applied to a flat cable comprising: a plurality of conductors; and a pair of films having adhesive applied thereto and sandwiching each of the plurality of conductors at predetermined intervals, and it also applied to a plasma display device using the flat cable, the device comprising: a plasma display panel; a driving circuit for applying voltage to an electrode of the plasma display panel; and a control circuit for controlling the driving circuit, and it has the characteristics as follows.

(1) At least one of the conductor on a side of the flat cable and a conductor on a side of a connector to which the conductor on the side of the flat cable is electrically connected is made of a material containing no lead. Further, an electrode is formed in a connecting portion of the flat cable by removing one of the pair of films to which the adhesive is applied so that the conductor is exposed, and an insulating member having a partition wall between adjacent electrodes is provided to a part of the electrode where the film has been removed.

(2) A height of the insulating member is designed to be equal to or larger than a thickness of the electrode of the flat cable and equal to or smaller than half a thickness of the flat cable.

(3) The interval of the plurality of conductors is 0.25 mm to 0.5 mm.

(4) The insulating member is a cover having openings in a hole shape or a comb shape formed on a part of the electrode where the film of the flat cable has been removed, so as to expose the electrode. The cover is formed of a polyimide plate or a glass epoxy plate.

(5) The insulating member is a protective layer having openings in a hole shape or a comb shape formed by a screen printing method on a part of the electrode where the film of the flat cable has been removed, so as to expose the electrode. The protective layer is made of epoxy.

(6) The insulating member is a resist formed by applying a negative resist to a part of the electrode where the film of the flat cable has been removed, performing exposure and development from a rear surface, and then hardening the negative resist having openings in a hole shape or a comb shape formed on the part of the electrode where the film has been removed, so as to expose the electrode.

Effect of the Invention

The effects obtained by typical aspects of the present invention will be briefly described below.

According to the present invention, since the formed whisker does not reach the adjacent electrode, the short-circuit between electrodes can be prevented.

Further, according to the present invention, since the adhesive which produces the shavings is not exposed, the foreign particle is not produced at the time of insertion to the connector, and the contact failure can be reduced.

### BRIEF DESCRIPTIONS OF THE DRAWINGS

FIG. 1 is a diagram showing an example of structural members and product structure of a flat cable according to an embodiment of the present invention;

FIG. 2 is a diagram showing an example where a cover is provided as an insulating member to a connecting portion of the flat cable according to the embodiment of the present invention;

FIG. 3 is a diagram showing an example where another cover is provided as an insulating member to a connecting portion of the flat cable according to the embodiment of the present invention;

FIG. 4 is a diagram showing an example where a protective layer is provided as an insulating member to a connecting portion of the flat cable according to the embodiment of the present invention;

FIG. 5A to FIG. 5D are diagrams showing an example where a resist is provided as an insulating member to a connecting portion of the flat cable according to the embodiment of the present invention;

FIG. 6A and FIG. 6B are diagrams showing an example where the flat cable according to the embodiment of the present invention is connected to an insertion-type connector;

FIG. 7A and FIG. 7B are diagrams showing an example where the flat cable according to the embodiment of the present invention is connected to an insulation displacement connector;

FIG. 8 is a diagram showing an example of a configuration of a plasma display device using the flat cable according to the embodiment of the present invention;

FIG. 9 is a diagram showing an example of a state where whisker is formed in a contact portion between an electrode of FFC and an electrode of a connector; and

FIG. 10A to FIG. 10D are diagrams showing an example of a state where a foreign particle of shaved adhesive is trapped at a contact portion between an electrode of FFC and an electrode of a connector in a conventional technology.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

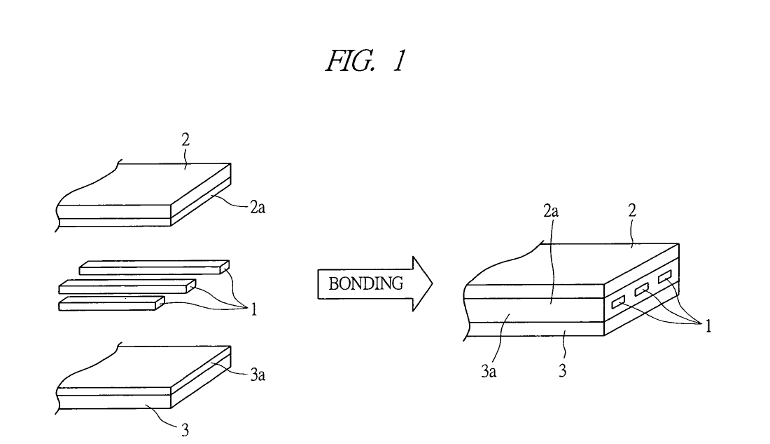

First, an example of the structure of the flat cable according to an embodiment of the present invention will be described with reference to FIG. 1. FIG. 1 is a diagram showing an example of structural members and product structure of the flat cable.

The flat cable according to this embodiment is not limited to this but is applied to, for example, an FFC, and it comprises: a plurality of conductors 1; and a pair of films 2 and 3 to which adhesives 2a and 3a are applied. This flat cable is completed as a product by sandwiching each of the plurality of conductors 1 at predetermined intervals between the pair of films 2 and 3 having the adhesives 2a and 3a and laminating the same from above and below.

For example, this flat cable is formed from the materials described below and has the dimensions as follows. The conductor 1 is made of a lead-free material containing tin and others. The adhesives 2a and 3a are made of a flameproof polyester material, and the films 2 and 3 are made of a polyester material. The FFC is formed to have a thickness of about 0.3 mm. The conductors 1 are formed to have a thickness of about 0.1 mm and a width of about 0.3 mm, and the interval therebetween is set to about 0.25 mm to 0.5 mm. The films 2 and 3 having the adhesives 2a and 3a applied thereto are formed to have a thickness of about 0.15 mm.

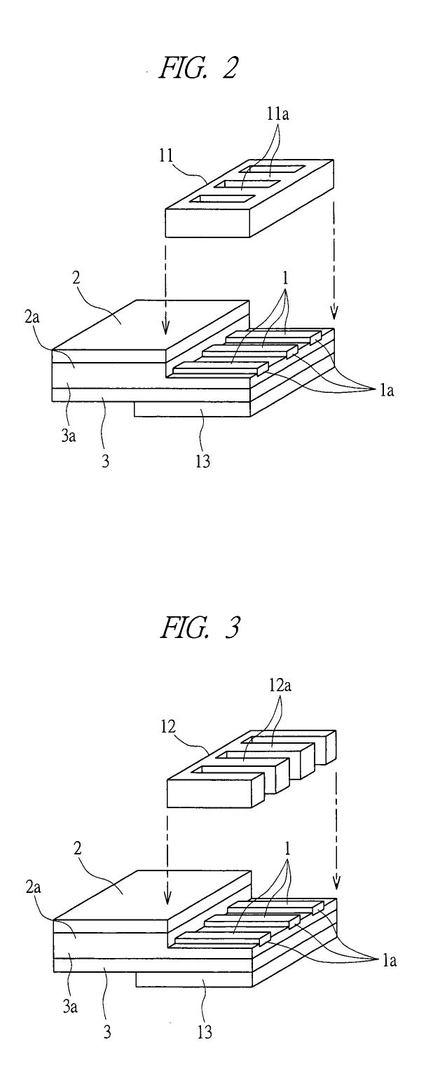

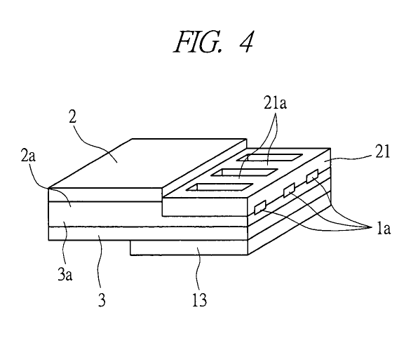

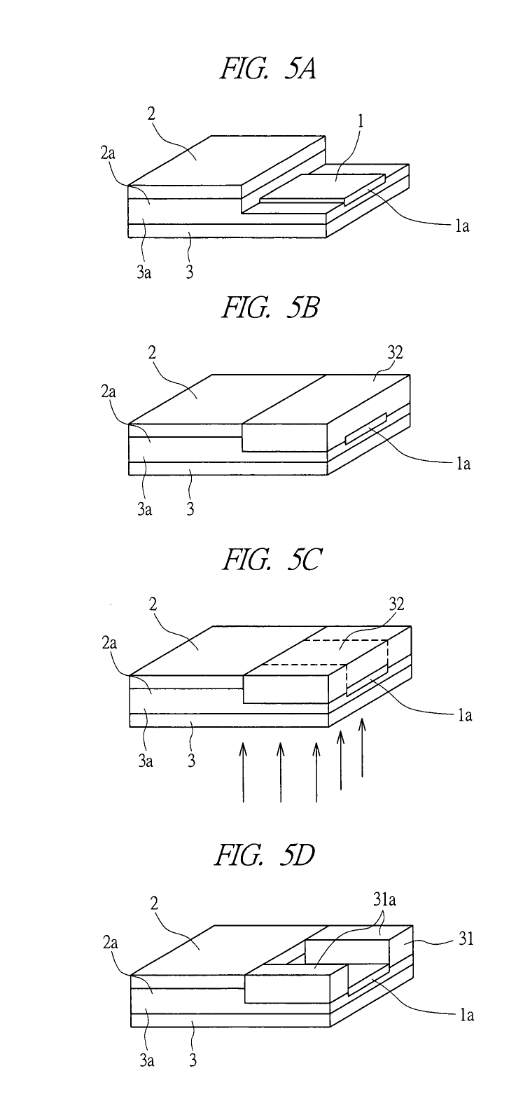

Next, an example of the case where an insulating member is provided to a connecting portion of the flat cable will be described with reference to FIG. 2 to FIG. 5. FIG. 2 and FIG. 3 show the case of providing a cover, FIG. 4 shows the case of providing a protective layer, and FIG. 5A to FIG. 5D show the case of providing a resist, respectively.

As shown in FIG. 2 and FIG. 3, in the connecting portion of the flat cable, the film 2 on one side (connection side) is removed so as to expose the conductors 1 to form the electrodes 1a. For the part of the electrodes 1a where the film 2 is removed, a cover 11 having partition walls 11a between the adjacent electrodes 1a and a cover 12 having partition walls 12a between the adjacent electrodes 1a are provided, respectively. In the covers 11 and 12, openings in a hole shape as shown in FIG. 2 or openings in a comb shape as shown in FIG. 3 are formed so that the part of the electrodes 1a is exposed. Further, since the partition walls 11a and 12a of the covers 11 and 12 make contact with the part of the adhesive 3a between the electrodes 1a, the part of the adhesive 3a is not exposed.

The covers 11 and 12 are formed from, for example, a polyimide or glass epoxy plate and are adhered with adhesive and the like. Also, the height of the covers 11 and 12 is designed to be equal to or larger than the thickness of the electrode 1a of the flat cable and equal to or smaller than half the thickness of the flat cable, for example, 0.15 mm.

Also, in the connecting portion of the flat cable, a reinforcing plate 13 is adhered onto a rear side opposite to the connection side where the covers 11 and 12 are provided.

As shown in FIG. 4, in the connecting portion of the flat cable, a protective layer 21 having partition walls 21a between adjacent electrodes 1a similar to the covers 11 and 12 is provided for the part of the electrodes 1a where the film 2 is removed (an example corresponding to that shown in FIG. 2 is shown, and the same is true of the case corresponding to the example shown in FIG. 3). Also in this protective layer 21, the part of the electrodes 1a is exposed and the part of the adhesive 3a between the electrodes 1a is not exposed. In this protective layer 21, openings in a hole shape or a comb shape are formed on the part corresponding to the electrodes 1a of the flat cable by the screen printing method. More specifically, after a printing plate which masks the part of the electrode 1a is formed, the printing plate is mounted on the part of the electrode 1a on the connection side, and then the material of the protective layer 21 is supplied from above the plate, thereby forming the protective layer 21. This protective layer 21 is made of, for example, epoxy.

As shown in FIG. 5, in the connecting portion of the flat cable, similar to the covers 11 and 12 described above, a resist 31 having partition walls 31a between the adjacent electrodes 1a is provided to the part of the electrode 1a (only one electrode 1a is illustrated) where the film 2 is removed. Also in this resist 31, the part of the electrode 1a is exposed and the part of the adhesive 3a between the electrodes 1a is not exposed. This resist 31 is formed by the steps of: preparing a flat cable in which the film 2 is removed and the electrode 1a is formed in the connecting portion as shown in FIG. 5A; applying a negative resist 32 to the part of the electrode 1a where the film 2 is removed as shown in FIG. 5B; performing the exposure and development from a rear surface as shown in FIG. 5C; and forming openings in a hole shape or a comb shape by the etching for the part of the electrode 1a and hardening the remaining resist 31 as shown in FIG. 5D.

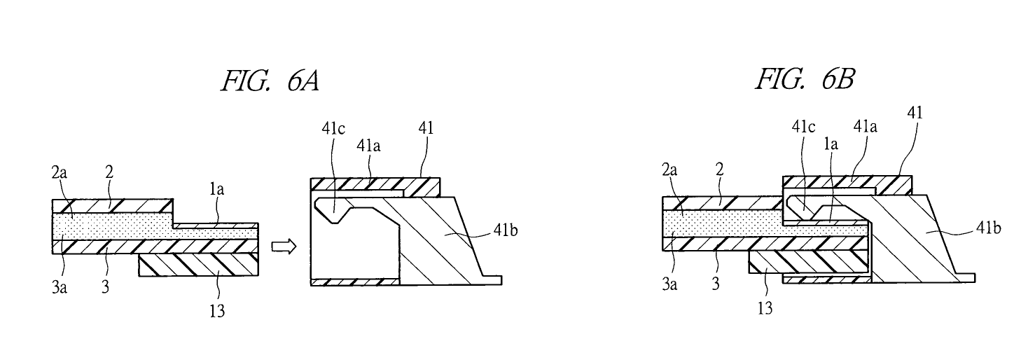

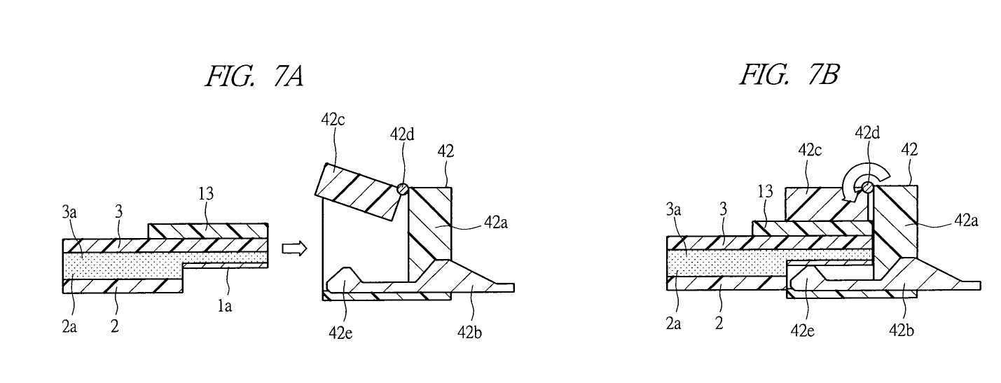

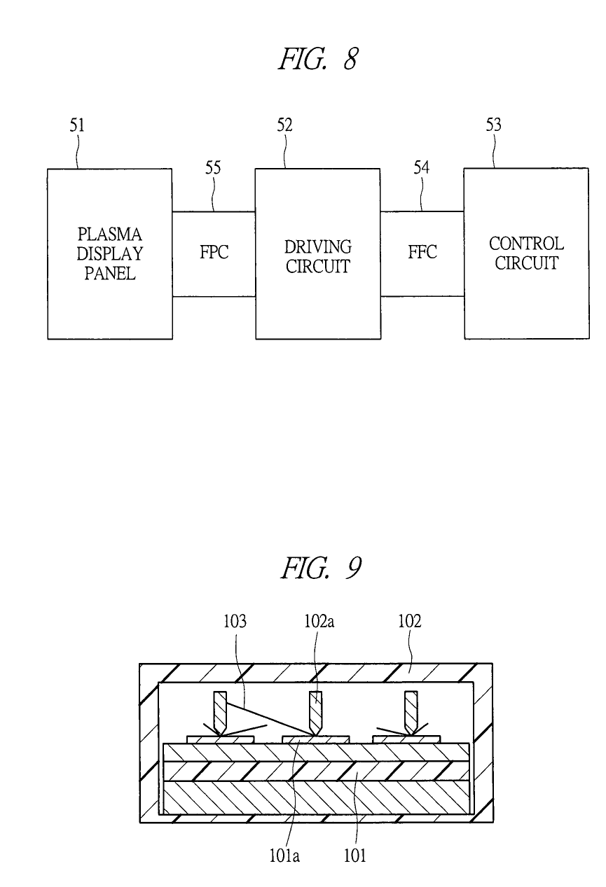

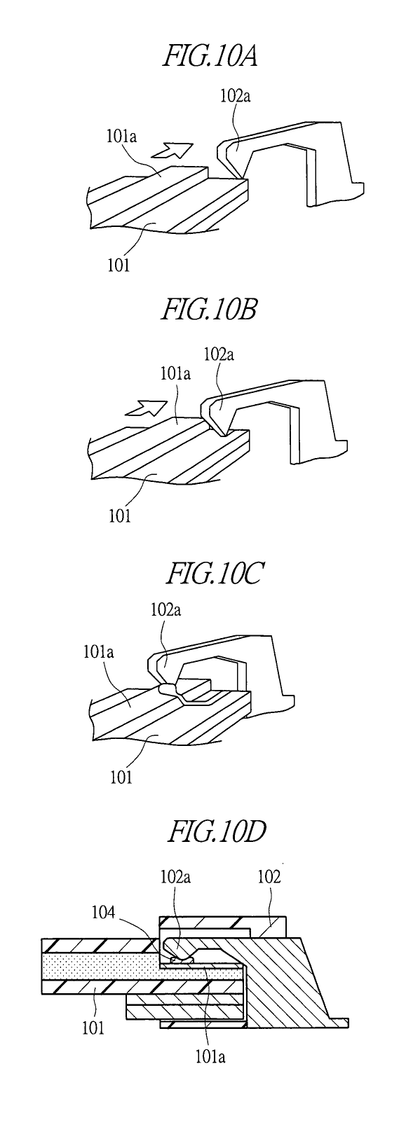

Next, an example of the case where the flat cable is connected to the connector will be described with reference to FIG. 6 and FIG. 7. FIG. 6A and FIG. 6B show an insertion-type connector and FIG. 7A and FIG. 7B show an insulation displacement connector. Note that, in FIG. 6 and FIG. 7, the cross section of the part where the electrode is exposed is shown and the insulating member is not illustrated.

As shown in FIG. 6, the insertion-type connector 41 has a contact 41b in a housing 41a. The contact 41b has one end electrically connected to the substrate on which the connector 41 is mounted and the other end electrically connectable to the electrode 1a of the flat cable.

When the flat cable shown in FIG. 2 to FIG. 5 is to be inserted into this insertion-type connector 41, the flat cable is inserted into the insertion port of the connector 41 with the side of the exposed electrode 1a of the flat cable facing up as shown in FIG. 6A. Then, as shown in FIG. 6B, after inserting the flat cable, the electrode 1a of the flat cable makes contact with an electrode 41c at the contact tip of the connector 41. In this manner, the electrode 1a of the flat cable can be electrically connected to the electrode 41c of the connector 41.

In this case, a part of the adhesive 3a between the electrodes 1a of the flat cable is not exposed because the partition walls 11a, 12a, 21a and 31a of the covers 11 and 12, the protective layer 21 and the resist 31 described above are in contact thereto. Therefore, this flat cable is effectively applied even to the case of the oblique insertion and the misalignment at the time of inserting the flat cable into the connector 41 because the production of shavings of the adhesive 3a can be suppressed.

Further, although the electrode 1a of the flat cable is made of a lead-free material, the electrode 41c of the connector 41 is made of, for example, a material containing lead. Alternatively, it can be applied also to the reverse case and the case where both of them are made of a lead-free material. Although the whisker formation occurs in the case where at least one of them is made of a lead-free material, the partition walls 11a, 12a, 21a and 31a of the covers 11 and 12, the protective layer 21 and the resist 31 described above effectively work in such a case.

As shown in FIG. 7, an insulation displacement connector 42 has a contact 42b and a retainer plate 42c in a housing 42a. The contact 42b has one end electrically connected to the substrate on which the connector 42 is mounted and the other end electrically connectable to the electrode 1a of the flat cable. The retainer plate 42c is attached to the housing 42a so as to rotate around a rotation shaft 42d as a fulcrum, and it holds the flat cable from the rear side thereof in the state where the flat cable is inserted.

When the flat cable shown in FIG. 2 to FIG. 5 is to be inserted into this insulation displacement connector 42, the flat cable is inserted into the insertion port of the connector 42 with the side of the exposed electrode 1a of the flat cable facing down as shown in FIG. 7A. At this time, the retainer plate 42 is in an open state. Then, after inserting the flat cable, the retainer plate 42c is rotated to hold the rear surface of the flat cable, and the electrode 1a of the flat cable is brought into contact with the electrode 42e at the contact tip of the connector 42 as shown in FIG. 7B. In this manner, the electrode 1a of the flat cable can be electrically connected to the electrode 42e of the connector 42. Also in this insulation displacement connector 42, similar to the insertion-type connector 41 described above, the flat cable effectively works for the suppression of the production of the shavings of the adhesive 3a and the whisker formation.

Next, an example of a configuration of a plasma display device using a flat cable will be described with reference to FIG. 8. FIG. 8 is a diagram showing an example of a configuration of a plasma display device.

The plasma display device comprises: a plasma display panel 51; a driving circuit 52 for applying voltage to an electrode of the plasma display panel 51; a control circuit 53 for controlling the driving circuit 52; and others. In this configuration, for example, the driving circuit 52 and the control circuit 53 are connected by the flat cable of an FFC 54 described above, and the plasma display panel 51 and the driving circuit 52 are connected by an FPC (flexible printed circuit) 55 which is another example of the flat cable.

The structure of the constituent components of the plasma display device is not illustrated. However, an example thereof will be described as follows. The following description will be made with using the three-electrode structure as an example. However, it is needless to say that it can be similarly applied to the four-electrode structure and others.

The plasma display panel 51 is constituted of a front plate made of glass and a rear plate similarly made of glass. In the front plate, X electrodes and Y electrodes which repeatedly perform discharges are alternately disposed in parallel to each other. In this front plate, the electrode group including the X electrodes and the Y electrodes is covered with a dielectric layer, and a surface of the dielectric layer is covered with a protective film made of magnesium oxide (MgO) or the like. In the rear plate, address electrodes extending in a direction almost orthogonal to the electrode group including the X electrodes and the Y electrodes are disposed and covered with a dielectric layer. On both sides of the address electrode, barrier ribs are disposed, which partition the cells in the column direction. Further, phosphors which are excited by ultraviolet to generate visible lights of red (R), green (G) and blue (B) are applied to the dielectric layer on the address electrode and the side surface of the barrier rib.

The front plate and the rear plate are bonded so that the protective layer and the barrier ribs are brought into contact with each other, and discharge gases such as neon (Ne) and xenon (Xe) are filled in the spaces therebetween, thereby constituting the plasma display panel. In a module of the driving circuit 52 and the control circuit 53 for controlling and driving the plasma display panel 51, an X driving circuit for applying voltage to the X electrodes of the plasma display panel 51, a Y driving circuit for applying voltage to the Y electrodes of the plasma display panel 51, an address driving circuit for applying voltage to the address electrodes of the plasma display panel 51, and a control circuit for controlling these driving circuits are provided.

In the plasma display device constituted as described above, the X electrode and the Y electrode mainly perform the sustain discharge for the display light emission. The sustain discharge is performed by repeatedly applying voltage pulses between the X electrode and the Y electrode. Further, the Y electrode also functions as a scanning electrode when writing the display data. On the other hand, the address electrode selects the discharge cell to be lit and applies the voltage for performing the writing discharge for selecting the discharge cell between the Y electrode and the address electrode.

Since the discharge of the plasma display panel can take only binary states of an ON state and an OFF state, the intensity of luminance, that is, the grayscale is expressed by the number of times of the light emission. Therefore, a frame is divided into a plurality of sub-fields. Each of the sub-fields includes a reset period, an address period and a sustain discharge period (sustain period). In the reset period, regardless of the lighting state in the previous sub-field, the operation for setting all the discharge cells to an initial state, for example, to a state where the charge of the barrier rib is erased is performed. In the address period, selective discharges (address discharge) are performed in order to determine the state of ON and OFF of the discharge cell based on the display data, and the wall charge for setting the discharge cell to an ON state is selectively formed. In the sustain discharge period, the discharge is repeated in the discharge cell in which charge of the barrier rib is formed by the address discharge, and a predetermined light is emitted. The driving as described above is controlled by the X driving circuit, the Y driving circuit and the address driving circuit through the control circuit.

As described above, according to the present embodiment, as an insulating member having a partition wall between adjacent electrodes 1a, the covers 11 and 12, the protective layer 21 and the resist 31 which expose only the part of the electrode 1a and have the partition wall in contact to the adhesive 3a between the electrodes 1a are provided for the part of the electrode 1a where the film 2 of the flat cable is removed. Therefore, the effects as follows can be achieved.

(1) Since the partition walls 11a, 12a, 21a and 31a of insulating members such as the covers 11 and 12, the protective layer 21 and the resist 31 are in contact to the part of the adhesive 3a between the electrodes 1a, the protrusion of the whisker can be suppressed and the whisker does not reach the adjacent electrode 1a. Therefore, the short-circuit between the electrodes 1a can be prevented.

(2) Since only the part of the electrode 1a is exposed by providing insulating members such as the covers 11 and 12, the protective layer 21 and the resist 31, the adhesive 3a which is a source of the shavings is not exposed. Therefore, foreign particles are not produced at the time of inserting the flat cable into the connector, and thus the contact failure can be reduced.

(3) Since the short-circuit between adjacent electrodes due to whisker formation and the contact failure due to the foreign particle between electrodes can be prevented, highly reliable flat cables such as FFC 54 and FPC 55 and a plasma display device using the flat cable can be provided.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention relates to a technology for a flat cable. In particular, it can be effectively applied to an FFC used in a plasma display device and further applied to an FPC.

1. A flat cable, comprising: a plurality of conductors; and a pair of films having adhesive applied thereto and sandwiching each of the plurality of conductors at predetermined intervals,
wherein at least one of the conductor on a side of the flat cable and a conductor on a side of a connector to which the conductor on the side of the flat cable is electrically connected is made of a material containing no lead, and
an electrode is formed in a connecting portion of the flat cable by removing one of the pair of films to which the adhesive is applied so that the conductor is exposed, and an insulating member having a partition wall between adjacent electrodes is provided to a part of the electrode where the film has been removed.

2. The flat cable according to claim 1,
wherein a height of the insulating member is designed to be equal to or larger than a thickness of the electrode of the flat cable and equal to or smaller than half a thickness of the flat cable.

3. The flat cable according to claim 1,
wherein the interval of the plurality of conductors is 0.25 mm to 0.5 mm.

4. The flat cable according to claim 1,
wherein the insulating member is a cover having openings in a hole shape or a comb shape formed on a part of the electrode where the film of the flat cable has been removed, so as to expose the electrode.

5. The flat cable according to claim 4,
wherein the cover is formed of a polyimide plate or a glass epoxy plate.

6. The flat cable according to claim 1,
wherein the insulating member is a protective layer having openings in a hole shape or a comb shape formed by a screen printing method on a part of the electrode where the film of the flat cable has been removed, so as to expose the electrode.

7. The flat cable according to claim 6,
wherein the protective layer is made of epoxy.

8. The flat cable according to claim 1,
wherein the insulating member is a resist formed by applying a negative resist to a part of the electrode where the film of the flat cable has been removed, performing exposure and development from a rear surface, and then hardening the negative resist having openings in a hole shape or a comb shape formed on the part of the electrode where the film has been removed, so as to expose the electrode.

9. A plasma display device, comprising: a plasma display panel; a driving circuit for applying voltage to an electrode of the plasma display panel; and a control circuit for controlling the driving circuit,
wherein a flat cable is used for at least one of connections between the plasma display panel and the driving circuit and between the driving circuit and the control circuit,
the flat cable comprises: a plurality of conductors; and a pair of films having adhesive applied thereto and sandwiching each of the plurality of conductors at predetermined intervals,
at least one of the conductor on a side of the flat cable and a conductor on a side of a connector to which the conductor on the side of the flat cable is electrically connected is made of a material containing no lead, and
an electrode is formed in a connecting portion of the flat cable by removing one of the pair of films to which the adhesive is applied so that the conductor is exposed, and an insulating member having a partition wall between adjacent electrodes is provided to a part of the electrode where the film has been removed.
